(19) United States
(12) Patent Application Publication
(10) Pub. No.: US 2008/0276792 A1
(43) Pub. Date: Nov. 13, 2008

(54) LYRICS SUPERIMPOSED ON VIDEO FEED

(76) Inventors: Christopher L. Bennetts, Hsin Tien City (TW); Christopher W. Larsen, Houston, TX (US); Nozomu Yasui, Taipei (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/745,221

(22) Filed: May 7, 2007

(51) Int. Cl. G10H 1/36

(52) U.S. Cl. 84/610

(57) ABSTRACT

A system comprises a camera, a display, and logic coupled to the camera and display. The logic causes a video feed from the camera to be displayed on the display and lyrics to be superimposed on the displayed video feed.

### BACKGROUND

Karaoke, an activity in which people sing along with recorded music, has enjoyed tremendous popularity. Advanced features are particularly attractive to the Karaoke market.

### BRIEF DESCRIPTION OF THE DRAWINGS

For a detailed description of exemplary embodiments of the invention, reference will now be made to the accompanying drawings in which:

FIG. 1 shows a system in accordance with embodiments of the invention;

FIG. 2 shows an illustrative embodiment in which song lyrics are superimposed on a live video feed; and

FIG. 3 shows a method in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

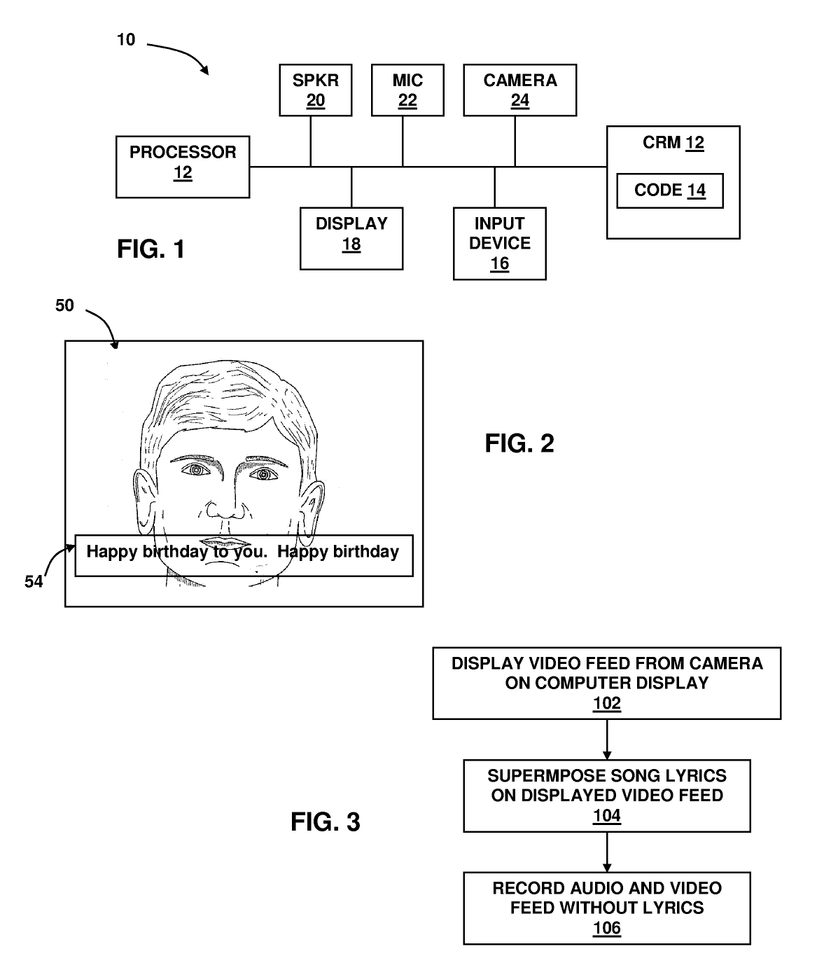

FIG. 1 shows a system 10 in accordance with embodiments of the invention. As shown, system 10 comprises a processor 12 coupled to a computer-readable medium (CRM) 12, an input device 16, a display 18, a speaker 20, a microphone 22 and a camera 24. n at least embodiment, the processor 12 executing code 14 causes system 10 to perform one or more of the functions described herein attributable to system 10. Computer-readable medium 12 comprises volatile storage (e.g., random access memory), non-volatile storage (e.g., hard disk drive, Flash memory, read-only memory, compact disc read-only memory, etc.), and combinations thereof. A user of system 10 interacts with input device 16 and display 18 to operate system 10. In various embodiments, the system 10 comprises a computer (e.g., desktop, notebook, etc.).

The camera 24 is a video camera in accordance with various embodiments. The camera 24 may be provided in a housing of the display 18 such that a user seated in front of the system 10 is in view of the camera 24. A video feed from the camera 24 is displayed on display 18. As such, the user can view him or herself in front of the system 10. FIG. 2 illustrates a screen shot of the display 18 in which a user of the computer is shown facing the camera.

The code 14 comprises a Karaoke application that enables a user to sing along with music played through speaker 20. In accordance with various embodiments, the code 14 enables a user to select a song to be played through speaker 20. The song may be a song stored in CRM 12 or downloaded from a network. The code 14 also causes lyrics associated with the song to be shown on display 18 while a vide feed from the camera 24 is being displayed. FIG. 2 illustrates lyrics 54 superimposed on top of the video feed 50 from the camera 24. The code 14 also enables the user to sing into microphone 22. As such, the user can view him or herself singing a song whose lyrics are superimposed on the live video feed from the camera 24. The user sings along with the lyrics which are timed to the song playing through speaker 20.

In at least some embodiments, the music file being played through speaker 20 comprises audio content and text content (i.e., the lyrics). Suitable file formats for such music files comprise the Musical Instrument Digital Interface (MIDI) Karaoke (.KAR) file format and the MPEG-1 Audio Layer-3 (MP3)+text (.LRC) file format.

In various embodiments, the code 14 records the displayed video feed, without the lyrics, as well as the audio detected by the microphone 22 while the video feed is being displayed. The recording may comprise storing digital data representative of the audio and video in the CRM 12 in the form of, for example, a file. The code 14 enables a user to select the recording to be played back at a later time as desired. In some embodiments, only the audio is recorded while in other embodiments only the video is recorded.

In some embodiments, a pre-recorded video file, photograph, or slideshow can be displayed on display 18 instead of a live video feed from the camera 24. In such embodiments, the lyrics are superimposed on such a video file, photograph, or slideshow. A slideshow in this regard may comprise only still photographs or a combination of still photographs and video. Slide shows may contain content that is stored locally on system 10 or streamed from a remote entity across a network (e.g., the Internet).

FIG. 3 shows a method comprising actions 102, 104, and 106. At 102, the method comprises displaying the video feed from the camera on the computer display 18. At 104, the method comprises superimposing the song lyrics on the displayed video feed. At 106, the method comprises recording the audio and video feed without the superimposed lyrics.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a camera;
a display; and
logic coupled to said camera and microphone, said logic causing a video feed from said camera to be displayed on said display and lyrics to be superimposed on said displayed video feed.

2. The system of claim 1, further comprising a user interface by which a user selects a song whose lyrics are subsequently superimposed on said displayed video feed.

3. The system of claim 1 further comprising a microphone coupled to said logic, wherein said microphone detects audio while the video feed and lyrics are displayed.

4. The system of claim 1 wherein said logic causes audio detected by a microphone while the video feed is displayed to be recorded.

5. The system of claim 1 wherein said logic causes said displayed video feed as well as audio detected by a microphone while the video feed is displayed to be recorded.

6. The system of claim 1 wherein said logic causes said displayed video feed, without said lyrics, as well as audio detected by a microphone while the video feed is displayed to be recorded.

7. The system of claim 1 wherein said display comprises a housing containing said camera.

8. The system of claim 1 further comprising a speaker through which music is played while said lyrics are being superimposed on said displayed video feed.

9. A method, comprising:
displaying a video feed from a camera on a computer display; and
superimposing song lyrics on said displayed video feed.

10. The method of claim 9 further comprising receiving an audio signal while displaying said video feed.

11. The method of claim 10 further comprising recording said audio signal.

12. The method of claim 10 further comprising recording said audio signal and said video feed.

13. The method of claim 9 further comprising recording said video feed.

14. The method of claim 9 further comprising recording said video feed but not said song lyrics.

15. A computer-readable medium (CRM) comprising software that, when executed by a processor, causes the processor to:
display a video feed from a camera on a computer display; and
superimpose song lyrics on said displayed video feed.

16. The CRM of claim 15 wherein said software further causes said processor to receive an audio signal while said video feed is being displayed.

17. The CRM of claim 16 wherein said software further causes said processor to record said audio signal.

18. The CRM of claim 16 wherein said software further causes said processor to record said audio signal and said video feed.

19. The CRM of claim 15 wherein said software further causes said processor to record said video feed.

20. The CRM of claim 15 wherein said software further causes said processor to record said video feed but not said song lyrics.
